(19) United States
(12) Patent Application Publication
(10) Pub. No.: US 2026/0319695 A1
(43) Pub. Date: Oct. 15, 2026

(54) NOISE RECYCLING DECODER FOR MULTI-LEVEL FLASH MEMORY

(71) Applicant: TECHNION RESEARCH & DEVELOPMENT FOUNDATION LIMITED, Haifa (IL)

(72) Inventors: Alejandro COHEN, Haifa (IL); Yuval CASSUTO, Haifa (IL); Gilli HOROWITZ HADAYO, Haifa (IL)

(21) Appl. No.: 19/642,992

(22) Filed: Apr. 9, 2026

Related U.S. Application Data
(60) Provisional application No. 63/786,336, filed on Apr. 10, 2025.

(51) Int. Cl. G06F 3/06

(52) U.S. Cl. CPC G06F 3/0655; G06F 3/0604; G06F 3/0679

(57) ABSTRACT

A multilayered memory storage device may include a cell array of N multilevel memory cells (MLCs), each maintaining a voltage level representing a respective multilayered symbol. A memory interface circuit may include branches corresponding to respective layers of the multilayered symbols, and may be configured to obtain a quantized reading of the voltage levels from the N MLCs. In a one branch corresponding to a layer of higher bit significance, the circuit may recover a first message and determines a digital noise level of a reading of at least one cell in that branch. In one or more second branches corresponding to layers of lower bit significance, the circuit may refine the quantized reading based on the digital noise level to recover one or more second respective messages, thereby recycling noise information from the first branch to improve recovery accuracy.

### CROSS-REFERENCE TO RELATED APPLICATIONS

This application claims priority of U.S. Application No. 63/786,336, titled “NOISE RECYCLING DECODER FOR MULTI-LEVEL FLASH MEMORY”, filed 10 Apr. 2025, which is hereby incorporated by reference in its entirety.

### FIELD OF INVENTION

The present invention relates to multi-level cell (MLC) flash memory systems, and more particularly to a noise recycling decoder for improving storage rates and bit error performance in MLC flash memory devices.

### BACKGROUND

Flash memory has become a crucial component in modern storage systems due to its non-volatile nature, high density, and low power consumption. As demand for data storage continues to grow, multi-level cell (MLC) flash memory architectures have been developed to increase storage capacity. MLC flash memory allows each cell to store multiple bits of information by utilizing several voltage levels within a single cell.

However, the increased storage density in MLC flash memory comes with challenges. As more bits are stored per cell, the voltage margins between adjacent levels decrease, making the cells more susceptible to noise-induced errors. This reduction in noise tolerance can lead to higher bit error rates, potentially compromising data integrity and reliability.

Various approaches have been explored to address the reliability concerns in MLC flash memory. These include the use of error correction codes, such as BCH and LDPC codes, to detect and correct errors during read operations. Additionally, techniques for adjusting read and write voltages have been proposed to mitigate the effects of noise and cell-to-cell interference.

Another area of focus has been the development of more sophisticated reading techniques. Some methods employ multiple read operations with different voltage thresholds to obtain a finer estimation of the cell's voltage level. This soft information can then be utilized by advanced decoding algorithms to improve error correction performance.

The mapping between binary data and cell voltage levels also plays a role in the overall system performance. Different mapping schemes, such as Gray mapping, have been utilized to minimize the bit error rate when noise causes shifts between adjacent voltage levels.

As the storage density of flash memory continues to increase, there is an ongoing need for improved decoding techniques that can maintain or enhance reliability while supporting higher storage rates. Advancements in this area could potentially enable more efficient and robust flash memory systems for a wide range of applications, from consumer electronics to data centers.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The foregoing general description of the illustrative embodiments and the following detailed description thereof are merely exemplary aspects of the teachings of this disclosure and are not restrictive.

As elaborated herein, embodiments of the invention may exploit properties of noise in multi-level cell (MLC) memory devices (e.g., FLASH devices), employing a noise recycling decoder (NRD) scheme to improve storage metrics. As used herein, the term storage rate may refer to the total rate of information that may be reliably stored, which may be understood as the sum of the rates across all layers of the multilayered symbol. By reducing bit error rate (BER, e.g., the probability that the wrong bit value is read from a cell due to noise shift) through noise recycling, embodiments of the invention may allow for higher storage rates while maintaining reliability.

It may also be appreciated that the NRD scheme of the present invention may be characterized by low computational complexity, operating purely in the digital domain without requiring soft information or likelihood calculations for passing information between layers.

As explained herein, embodiments of the invention may employ multi-stage decoding in conjunction with a mapping scheme. As used herein, the term multi-stage decoding may indicate that layers of stored data may be decoded sequentially, beginning with the most significant bit (MSB) layer, where noise characteristics of significant bits are extracted, and exploited for subsequent decoding of less significant bits, thereby enhancing noise robustness.

Embodiments of the system may estimate digital noise characteristics based on previously decoded layers. This estimated noise information may then be applied to subsequent layer decoding processes, which may result in improved bit error rate (BER) performance in some instances. The proposed noise recycling (NR) technique may involve simultaneous reading of an entire MLC, allowing consistent, correlated noise realization across all layers within a cell.

For scenarios involving noise shifts across multiple representation levels, embodiments of the system may establish reliability bounds, such as upper bounds on system error probability. For example, the system error probability may be upper-bounded by the sum of the error probabilities of the individual layers. For each layer, the error probability may be upper-bounded by the probability of encountering more read errors than the error-correcting code can handle. These reliability bounds may be used to compare performance between different decoding schemes, such as NRD with Block Partition (BP) mapping versus independent decoding with Gray mapping.

The inventors have demonstrated that the proposed NRD solution may outperform independent decoding (ID) methods (e.g., in absence of noise recycling) using both BP and Gray mappings. For single-level noise shifts, analytical and simulation results suggested that the proposed scheme may outperform baseline ID schemes with BP mapping and no NR, while potentially achieving comparable performance to ID with Gray mapping and no NR.

According to some embodiments of the invention, a multilayered memory storage device may be provided. The device may include a cell array including N multilevel memory cells (MLCs), each MLC adapted to maintain a voltage level representing a respective multilayered symbol, where the N multilayered symbols together form a multilayered string.

The device may further include a memory interface circuit including a plurality of branches, and each branch corresponding to a respective layer of the multilayered symbols. The memory interface circuit may be configured to obtain a quantized reading of the voltage levels maintained in the N MLCs. In a first branch corresponding to a first layer of higher bit significance, the memory interface circuit may recover a first message from the quantized reading. The memory interface circuit may determine a first digital noise level of the first layer based on the first message. In one or more second branches, respectively corresponding to one or more second layers of lower bit significance, the memory interface circuit may refine the quantized reading based on the first digital noise level, and recover one or more second messages from the refined quantized reading, thereby recycling noise information from the first branch to improve recovery accuracy in the one or more second branches.

According to some embodiments, the memory interface circuit may be configured to receive a data access request from a host computing device. In response to the data access request, the memory interface circuit may perform the quantized reading of the N MLCs to obtain the first message and the one or more second messages, wherein the first message and the one or more second messages together constitute a multilayered message. The memory interface circuit may return the multilayered message to the host computing device as read data.

According to some embodiments, data may be stored on the MLCs based on a predetermined mapping scheme. The first branch may include a mapping module adapted to perform inverse mapping on the quantized reading, to generate a first read word including a plurality of binary values, each binary value representing crossing of a voltage threshold in a respective MLC at the first layer. The first branch may further include a decoder module, adapted to decode the first read word, thereby recovering the first message. The first branch may further include a noise recycling module, adapted to determine the first digital noise level of the first layer based on the first message.

According to some embodiments, each of the one or more second branches may include a correction module, adapted to (i) obtain the first digital noise level from the first branch and (ii) refine the quantized reading of that second branch based on the obtained first digital noise level. Each of the one or more second branches may further include a mapping module adapted to perform inverse mapping on the refined quantized reading, to generate a second read word including a plurality of binary values, each binary value representing crossing of a voltage threshold in a respective MLC at the layer corresponding to that second branch. One or more (e.g., each) of the one or more second branches may further include a decoder module, adapted to decode the second read word, thereby recovering the second message pertaining to that second branch.

According to some embodiments, at least one of the one or more second branches may include a noise recycling module, adapted to determine a second digital noise level based on the second message pertaining to that second branch.

A subsequent branch of the one or more second branches may include a correction module adapted to (i) obtain the first digital noise level from the first branch, (ii) obtain second digital noise levels from the at least one second branch and (iii) refine the quantized reading of the subsequent branch based on the obtained digital noise levels.

According to some embodiments, the memory interface circuit may be configured to obtain the quantized reading by simultaneously reading all layers of the MLCs in the cell array, thereby ensuring a correlated noise realization across all layers within each MLC.

Additionally, or alternatively, the memory interface circuit may be configured to operate in a discrete domain using hard-decision recovery, where refining the quantized reading in the one or more second branches may be based on discrete noise values calculated for one or more branches of higher bit significance, without requiring soft information or likelihood calculations.

According to another aspect of embodiments of the invention, a method of recovering a multilayered message from an array of N multilevel memory cells by a memory interface circuit may be provided. The method may include obtaining the array of N multilevel MLCs, where each MLC may be configured to store a respective multilayered symbol based on a predetermined mapping scheme, and wherein the N multilayered symbols together constitute a multilayered string.

Embodiments of the method may further include obtaining the memory interface circuit, wherein the memory interface circuit may include a plurality of branches, each branch corresponding to a respective layer and a respective bit significance of the multilayered symbols. The method may further include generating a quantized reading of voltage levels from the N MLCs.

Embodiments of the method may include, in a first branch of the memory interface circuit, corresponding to a first layer of higher bit significance, recovering a first message from the quantized reading. Embodiments may further include determining a first digital noise level of the first layer based on the first message.

Additionally, or alternatively, embodiments of the method may include, in at least one second branch of the memory interface circuit, corresponding to at least one second layer of lower bit significance, refining the quantized reading based on the first digital noise level. Embodiments of the method may further include recovering at least one second message from the refined quantized reading in the at least one second branch, thereby recycling noise information from the first branch to improve recovery accuracy in the at least one second branch. The first message and the at least one second message together may constitute the multilayered message.

According to some embodiments, recovering the multilayered message may include an iterative recovery process following decreasing bit significance across the plurality of branches, from a branch of a Most Significant Bit (MSB) layer to a branch of a Least Significant Bit (LSB) layer, and wherein each iteration may pertain to a respective branch.

According to some embodiments, a first iteration, pertaining to the branch of the MSB layer, may include applying inverse mapping on the quantized reading, to extract a read word pertaining to the MSB layer, wherein the read word may include a plurality of binary values, each binary value representing crossing of a voltage threshold in a respective MLC at the MSB layer.

The first iteration may further include decoding the read word to recover a message pertaining to the MSB layer, and calculating the digital noise level of the MSB layer based on the recovered MSB layer message.

According to some embodiments, each iteration save that pertaining to the branch of the MSB layer may include refining the quantized reading at a current branch corresponding to a current layer, based on a digital noise level of one or more layers of higher bit significance. Each such iteration may further include applying inverse mapping on the refined quantized reading, to extract a read word pertaining to the current layer, wherein the read word may include a plurality of binary values, each binary value representing crossing of a voltage threshold in a respective MLC at the current layer. Each such iteration may further include decoding the read word to recover a message pertaining to the current layer, and calculating the digital noise level of the current layer based on the recovered message of the current layer.

According to some embodiments, each iteration save that pertaining to the branch of the LSB layer may further include transferring the calculated digital noise level to a subsequent iteration, pertaining to a subsequent branch of a lower bit significance, for refining the quantized reading in the subsequent branch.

According to some embodiments, decoding the read word may further include applying error correction logic on the read word to correct the recovered message in the current layer.

According to some embodiments, calculating the digital noise level of the current layer may include generating an expected codeword based on the recovered message of the current layer, comparing the expected codeword with the read word of the current layer, and determining the digital noise level of the current layer based on the comparison.

Additionally or alternatively, calculating the digital noise level of the current layer may include employing a decoder to calculate estimated bit-values corresponding to respective indices of the read word, comparing the estimated bit-values with the read word of the current layer, and determining the digital noise level based on the comparison.

According to some embodiments, refining the quantized reading of the current layer may include accumulating digital noise levels determined in previous iterations, from an iteration pertaining to the branch of the MSB layer through an iteration immediately preceding a current iteration, and subtracting the accumulated digital noise levels from the quantized reading to produce the refined quantized reading of the current layer.

According to some embodiments, the predetermined mapping scheme may be a Block Partition (BP) mapping scheme. Determining the digital noise level of the current layer may include, based on the comparison, detecting a bit flip in an index of the read word, said index corresponding to an identified MLC. Determining the digital noise level may further include, based on bit significance of the current layer, determining an amplitude of the digital noise level in the identified MLC, and relying on the BP mapping to determine a sign of the digital noise in the identified MLC.

Additionally or alternatively, when the predetermined mapping scheme is a BP mapping scheme, the method may further include, based on the comparison, detecting a bit flip in an index of the read word of the current layer, said index corresponding to an identified MLC, and predicting occurrence of errors in at least one subsequent layer of the identified MLC, from the layer directly subsequent the current layer through the LSB layer.

Additionally, or alternatively, the predetermined mapping scheme may be a Gray mapping scheme. Determining the digital noise level of the current layer may include, based on the comparison, detecting a bit flip in an index of the read word, said index corresponding to an identified MLC, and based on bit significance of the current layer, determining an amplitude of the digital noise level in the identified MLC.

### BRIEF DESCRIPTION OF THE DRAWINGS

Non-limiting and non-exhaustive examples are described with reference to the following figures.

FIG. 1A is a block diagram depicting a system or device for multilayered memory storage, according to aspects of the present invention;

FIG. 1B is a schematic diagram of a multi-layer cell array, according to some embodiments of the invention;

FIG. 2 is a block diagram illustrating a memory interface module for processing multilevel symbol voltages, according to aspects of the present disclosure;

FIG. 3 is a schematic diagram, illustrating a hierarchical tree structure, which represents the organization of data bits across multiple layers, according to some embodiments of the invention;

FIG. 4 is a block diagram illustrating a noise recycling decoding system, according to an embodiment of the present disclosure;

FIG. 5 is a flow diagram depicting a method of decoding a stored multilayered symbol in a multilayered memory storage device, according to some embodiments of the invention; and

FIG. 6 is a flow diagram depicting a method of recovering a multilayered message from an array of N multilevel memory cells, according to some embodiments of the present invention.

### DETAILED DESCRIPTION

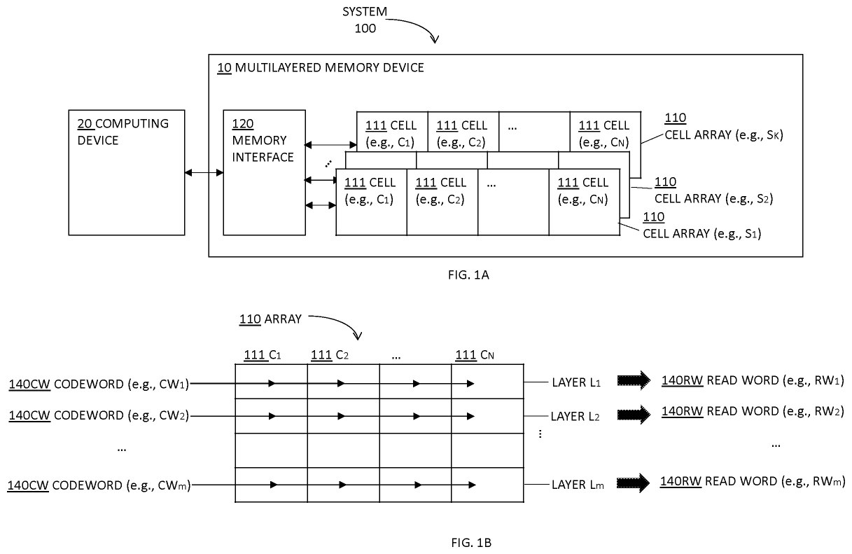

Reference is made to FIG. 1A, which is a block diagram illustrating a system 100 according to some embodiments of the invention. System 100 may include a multilayered memory device 10 and a computing device 20.

In some embodiments, multilayered memory device 10 may include one or more cell arrays 110, each adapted to store a multilayered string. Multilayered memory device 10 may further include a memory interface 120, adapted to interface cell arrays 110, so as to allow access (e.g., read or write) of computing device 20 to the stored multilayered strings.

Cell array 110 may include one or more (e.g., a plurality of) N memory cells 111. Each memory cell 111 of the N memory cells 111 may be a multilevel memory cell (MLC), adapted to maintain a voltage level representing a respective multilayered symbol (MLS). The N multilayered symbols together may form a multilayered string.

For example, multilevel memory cells 111 may be triple-bit level cells (TLCs), where each cell may be configured to maintain a 3-bit MLS, or quad-bit level cells (QLCs), where each cell may be configured to maintain a 4-bit MLS.

As shown in FIG. 1A, memory interface module 120 may be configured to facilitate communication between cell array(s) 110 and computing device 20. For example, memory interface module 120 may receive a read access request from computing device 20, to read content of a stored MLS. Memory interface module 120 may be adapted to obtain a quantized reading of the voltages maintained in the N memory cells 111, recover the stored MLS data from the quantized reading, and return the decoded value to computing device 20.

Reference is made to FIG. 1B, which is a schematic diagram illustrating structure of a cell array 110, according to some embodiments of the invention. As shown in the schematic example of FIG. 1B, cell array 110 may include multiple memory cells 111. In the example of FIGS. 1A and 1B, each cell array 110 may include a first MLC 111-C₁, a second MLC 111-C₂, and continuing up to an Nth MLC 111-C_{N}.

In some embodiments, each MLC 111 may be adapted to store data across multiple layers, including a first layer (denoted L₁) a second layer (denoted L₂), and so forth, continuing up to an m-th layer (denoted Lₘ). As described herein, multilayered memory device 10 may utilize a predetermined mapping scheme such as Block Partition (BP) mapping or Gray mapping to map multilayered symbol voltage levels to digital information.

As used herein, the term ‘layer’ may refer to a bit position or bit significance within the multilayered symbol, e.g., L₁ through Lₘ, where m is the number of bits stored per cell. The term ‘level’ or ‘voltage level’ may refer to one of the 2^{m} possible voltage representations that an m-bit cell may maintain. For example, a TLC (3 layers) MLC may have 2³=8 voltage levels.

As shown in FIG. 1B, the voltage levels maintained in a common layer (e.g., L₁) across all MLCs of an array 110 may be read as words 140RW. In an ideal noiseless environment, these read words would be stored and read from cell array 110 as codewords 140CW, and may be decoded to extract stored information referred to herein as messages. However, in practical applications, the reading of layers of the MLCs of an MLC array 110 may produce a noisy version of the codewords 140CW stored therein. This read data is referred to herein as read words 140RW.

Each read word 140RW may consist of a plurality of bits (e.g., N, as the number of cells), and may correspond to a specific layer. For example, a first read word (denoted RW₁) may correspond to the first layer L₁, a second read word (denoted RW₂) may correspond to the second layer L₂, and so forth, continuing through subsequent layers until the m-th layer (denoted read word RWₘ).

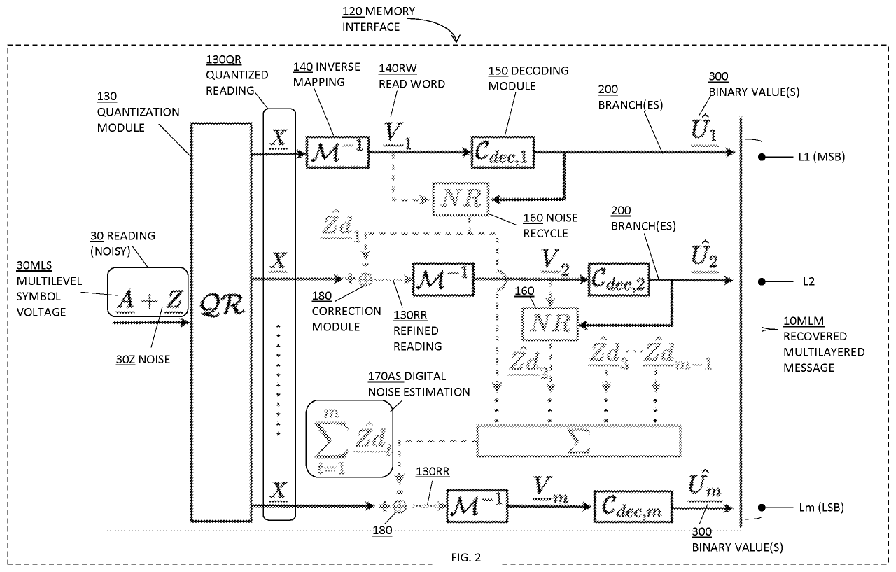

Reference is further made to FIG. 2, which is a block diagram illustrating a memory interface module 120 according to some embodiments of the invention. Memory interface module 120 of FIG. 2 may be the same as memory interface module 120 of FIG. 1A. As explained herein, memory interface module 120 may be configured to process data stored in the cell arrays 110 of multilayered memory device 10, to recover multi-layer messages therefrom.

As shown in FIG. 2, memory interface module 120 may read the content of a cell array 110 to obtain a reading 30 of the N multilayered symbols 30MLS stored therein. In some cases, reading 30 may be noisy, in a sense that multilevel voltage symbols 30MLS (also denoted ‘A’) may be accompanied by noise 30Z (also denoted ‘Z’). Noise 30Z may be modeled, for example, as a Gaussian noise, a Student's t-distribution noise signal and the like.

According to some embodiments, memory interface module 120 may obtain the quantized reading by simultaneously reading all layers of the MLCs in cell array 110, thereby ensuring a correlated noise realization across all layers within each MLC. Because all layers of a given MLC may be read at the same time, the noise affecting each layer within that MLC may share a common underlying noise component. This correlated noise realization may be beneficial for noise recycling, as it may allow the noise estimated from a decoded layer to be meaningfully applied as a correction to subsequent layers within the same MLC.

In some existing multilayer storage devices, soft-decision decoding may be employed, in which multiple read operations at different voltage thresholds may be performed to obtain probability information about each cell's value. This soft information, such as confidence scores or probability distributions, may then be used in likelihood calculations to pass information between layers and make more informed decoding decisions. Such approaches, however, may increase computational complexity and require additional read operations. In contrast, in some embodiments of the present invention, memory interface module 120 may operate in a discrete domain using hard-decision recovery. As explained herein, refining the quantized reading in one or more second branches may be based on discrete noise values calculated for one or more branches of higher bit significance, without requiring soft information or likelihood calculations.

Memory interface module 120 may include a quantization module 130 configured to process reading 30, and produce therefrom a quantized reading 130QR. For example, at each layer, quantization module 130 may compare each cell's voltage against a set of read voltage thresholds (e.g., V_{RD,1} through V_{RD,2}^{m}₋₁), to determine which of the 2^{m} possible representation levels the cell's voltage falls within. The result may be a discrete, quantized value for each cell.

As shown in FIG. 2, quantized reading 130QR may include a plurality of noisy, quantized cell representation levels, denoted as vectors X, where X=(X₁, X₂, . . . , X_{N})∈{1, 2, . . . , 2^{m}}^{N}, and where N is the number of cells, and m is the number of layers (bits per cell). In other words, each vector X may pertain to a specific layer L (e.g., L₁, L₂, . . . , Lₘ), and may include a quantized version of a read word 140RW stored at the respective layer L of cell array 110.

As shown in FIG. 2, memory interface module 120 may include a plurality of hierarchically ordered branches 200. Each branch 200 may match a respective layer (e.g., L₁, L₂, . . . , Lₘ) of the multilayered symbol 30MLS, and consequently a respective bit position or bi significance.

For example, a first branch may correspond to the first layer L₁, e.g., a most significant bit (MSB) of the multilayered symbols, a second branch may correspond to the second layer L₂ of the multilayered symbols and so forth, down to branch m that may correspond to layer Lₘ, e.g., the least significant bit (LSB) layer of the multilayered symbols.

One or more (e.g., each) branch 200 may be configured to process the quantized reading 130QR of the corresponding layer, optionally based on analysis of layers of higher bit significance, to recover a message encoded in read word of the matching layer. This message may be regarded as a slice, or a single-layer portion of a multilayered message encoded within the content of cell array 110.

In the context of multilayered memory storage, M(·) may represent a mapping function from a binary vector (digital data) to cell voltage levels (analog representation). During write operations, M(·) may determine which of the 2^{m} possible voltage levels corresponds to a given m-bit binary vector that is to be stored in a cell. Conversely, M⁻¹(·) may represent the inverse mapping, which converts read voltage levels back to binary values during read operations.

As shown in FIG. 2, one or more (e.g., each) branch 200 may include an inverse mapping module 140 (also denoted herein as M⁻¹). Quantization module 130 may bridge the analog-to-digital conversion by converting raw analog voltage readings into quantized digital representations. The inverse mapping module 140 (M⁻¹) may process these quantized readings 130QR to extract layer-specific binary values, thereby producing read words 140RW for each layer.

In other words, inverse mapping module 140 of each branch 200 may be configured to extract, from the quantized reading 130QR, a read word 140RW that corresponds to the matching layer. In other words, inverse mapping module 140 of a first branch 200 corresponding to layer L1 may produce a first read word 140RW, inverse mapping module 140 of a second branch 200 corresponding to layer L2 may produce a second read word 140RW, and so on. Read word 140RW may include N binary values, corresponding to the number of MLCs 111 where each binary value may represent crossing of a voltage threshold in a respective memory cell 111 at the matching layer. In FIG. 2, read words 140RW pertaining to layers {L₁, L₂, . . . , Lₘ}are respectively denoted {V₁, V₂, . . . , Vₘ}.

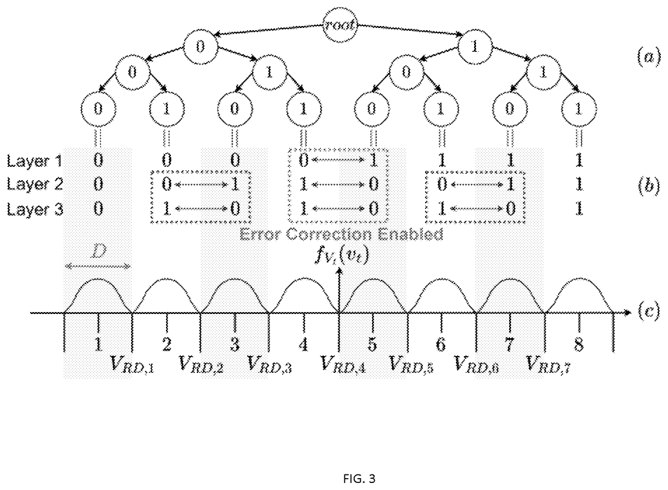

Reference is also made to FIG. 3, which is a schematic diagram, illustrating a hierarchical tree structure, which represents a first type of mapping, e.g., an organization of data bits across multiple layers, according to some embodiments of the invention. In the example of FIG. 3, the hierarchical tree structure may implement a block partition (BP) mapping scheme that may be used by the multilayered memory device 10, according to some embodiments of the invention.

As used herein, the term BP mapping may be understood as a symmetric partitioning tree structure, where each binary value at a given layer from the root (at the top of FIG. 3) is the parent of possible binary values at the next layer. In this hierarchical organization, each multilayered symbol (MLS) value may be obtained by traversing the tree based on the decoded bits from preceding layers.

In the example of FIG. 3, the hierarchical structure includes three layers (layers 1 through 3), where layer 1 corresponds to the MSB of the stored multilayered symbol, and layer 3 corresponds to the LSB of the stored multilayered symbol. Below the tree structure, read voltage threshold levels (e.g., boundaries between two adjacent MLSs that differ in their t-th bit) V_{RD,1} through V_{RD,7} are arranged along a horizontal axis.

In the example of FIG. X4, V_{RD,1} may represent the lowest threshold voltage level, between the values ‘1’ and ‘2’), and V_{RD,7} may represent the highest threshold voltage level, between the values ‘7’ and ‘8’. The read word 140RW of each layer (e.g., layer 1—MSB) may consist of N bits, e.g., one for each cell. Each bit may indicate crossing of a voltage threshold in a respective memory cell 111 at the matching layer.

Pertaining to the example of FIG. 3: a ‘1’ value of a cell-specific bit, in read word 140RW of layer 1 (MSB) may indicate a voltage in excess of the V_{RD,4} threshold value, corresponding to a stored multilayered symbol that is equal to, or greater than 5 (e.g., 5, 6, 7 or 8). In a complementary manner, a ‘0’ value of the cell-specific bit, in read word 140RW of layer 1 (MSB) may indicate voltage lower than the V_{RD,4} threshold, corresponding to a stored multilayered symbol that is lower than 5 (e.g., 1, 2, 3, or 4).

FIG. 3 also illustrates some useful characteristics of BP mapping. For example, in BP mapping, all subsets may differ only by rotation or translation, giving the mapping a repetitive, self-similar structure.

To illustrate this property, consider a TLC (8-level cell with 3 layers). At Layer 1 (MSB), the tree may split all 8 levels into two subsets: levels {1, 2, 3, 4} corresponding to bit value 0, and levels {5, 6, 7, 8} corresponding to bit value 1. At Layer 2, each subset from Layer 1 may be further split: the first subset may split into {1, 2} and {3, 4}, while the second subset may split into {5, 6} and {7, 8}. At Layer 3 (LSB), each subset may split into individual levels. The splitting pattern at Layer 2 within the first subset ({1, 2, 3, 4}→{1, 2} and {3, 4}) may be structurally identical to the splitting pattern within the second subset ({5, 6, 7, 8}→{5, 6} and {7, 8})—the difference being a translation (shift by 4 levels). This self-similar, repetitive structure may enable the decoding logic and noise analysis performed on one subset to be directly applied to any other subset of the same size, which may allow the noise recycling approach to work efficiently across all layers.

As shown in FIG. 2, one or more (e.g., each) branch 200 of memory interface module 120 may include a decoding module 150. Decoding module 150 may be adapted to process the read word 140RW extracted by the inverse mapping module 140, and produce therefrom a message 300 corresponding to the matching layer of the stored MLS. In other words, the decoder of a specific branch 200 may be configured to produce binary, digital representation of a message 300 (also denoted Uₜ∈{U₁, U₂, . . . , Uₘ}) based on read words 140RW (also denoted Vₜ∈{V₁, V₂, . . . , Vₘ}) of the respective layers (e.g., Lₜ∈{L₁, L₂, . . . , Lₘ}), and optionally further based on noise recycling 160, e.g., characteristics of noise from higher-significance layers.

A useful property of BP mapping is that if two neighboring MLSs differ in the t-th bit, they may also differ in all subsequent bits. For instance, in FIG. 3, MLS values 4 and 5 are neighbors that differ in Layer 1 (the MSB). Because they differ in Layer L₁, they also differ in Layer L₂ and Layer L₃ (all subsequent bits). This property creates a predictable bit-flip pattern: when noise causes a shift between neighboring MLSs that differ at layer t, memory interface 120 may predict that errors will also occur in all subsequent layers (t+1 through m). This predictable pattern may make it easier to detect errors after decoding each layer. Once an error is detected and corrected at layer t, the noise recycling decoder 150 may apply corrections that prevent errors from propagating to subsequent layers. Without noise recycling (as in independent decoding with BP mapping), a noise shift affecting layer t would affect all subsequent layers, increasing the overall bit error rate. This is why BP mapping may benefit from the noise recycling approach-the predictable structure may allow decoder 150 to identify noise shifts and apply corrections before decoding subsequent layers. This may be contrasted with other types of mapping, such as Gray mapping, where neighboring MLSs differ by only one bit. Under single-level noise shifts, post-decoding correction may be unnecessary for Gray mapping, whereas BP mapping may benefit from the noise recycling correction.

As explained herein, indices of read word 140RW may include values pertaining to a specific layer, but originating from different cells. For example, a read word 140RW for layer L₁ may comprise entries, or indices hold binary values from multiple respective memory cells 111 (e.g., 111-C₁, 111-C₂, . . . 111-C_{N}) within the cell array 110. These values may be processed collectively to determine the most likely correct value for that layer.

In some embodiments, the decoding process performed by decoder module 150 may further include applying error correction logic on read word 140RW to obtain the message 300. In some embodiments, decoder 150 may perform error correction, e.g., by using an appropriate code in that layer. For instance, if read word 140RW includes values from N different memory cells for layer L₁, decoder 150 may determine that the more likely value in that layer is ‘1’, based on read words it found in proximity to its input word. The decoding mechanism may be implemented as part of the error correction logic applied by decoding module 150 when processing the read word 140RW to obtain the message 300 (also denoted herein as Ú_{□}_{ₜ} vector).

Additionally, or alternatively, decoder 150 may perform error correction as facilitated by an implementation-specific encoding scheme. In a simple, non-limiting example, the encoding scheme for memory device 10 may be based on a redundancy code, and decoder 150 may apply a majority vote among the cell-specific values to correct errors in read word 140RW. For instance, if read word 140RW includes values from five different memory cells for layer L1, where three of those values are ‘1’ and two are ‘0’, decoder 150 may determine that the correct value for that layer is likely ‘1’ based on a majority vote. Other implementation-specific mechanisms of error correction may also be applied by decoder 150.

According to some embodiments, one or more branches 200 of memory interface module 120 may also include a Noise Recycle (NR) module 160. In the implementation example of FIG. 2, all branches, save that pertaining to the least significant bit layer, may include a proprietary NR module 160. NR module 160 may be configured to determine a digital noise level at the matching layer in at least one memory cell 111 based, at least on part, on decoded messages 300.

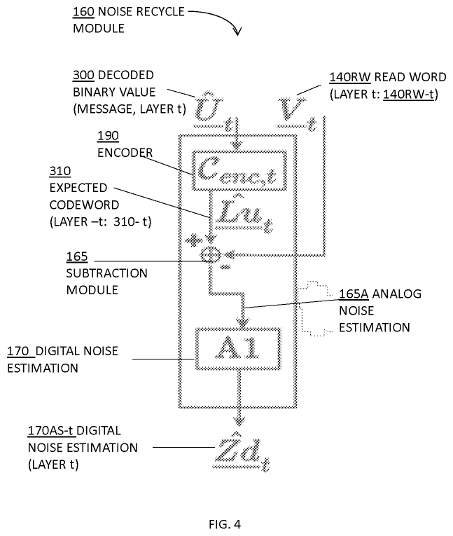

Reference is also made to FIG. 4, which is a block diagram illustrating en example for implementation of a noise recycling module 160, according to some embodiments of the invention. NR module 160 of FIG. 4 may be the same as one or more NR modules 160 depicted in FIG. 2.

In FIG. 4, the index ‘t’ represents a generic layer index, allowing the diagram to illustrate the NR module functionality for any layer from L1 through Lₘ (or through Lₘ₋₁, in embodiments where the LSB layer Lₘ may not include an NR module, as shown in FIG. 2).

As shown in FIG. 4, noise recycle module 160 may include a digital noise estimation module 170, adapted to estimate digital noise characteristics 170AS (also denoted herein as Z_{dt}) to be applied on a subsequent layer, e.g., pertaining to a lower-significance bit of the stored MLS.

In other words, NR module 160 of a first branch 200 corresponding to a first layer (e.g., L1 MSB) may be configured to determine a digital noise level 170AS in at least one memory cell 111 based at least in part on decoded message 300 of layer L1, to be used for refining the quantized reading 130QR in at least one subsequent layer (e.g., L2, L3, . . . Lm). NR module 160 of a second branch 200 corresponding to a second layer (e.g., L2) may be configured to determine a digital noise level 170AS in at least one memory cell 111 based at least in part on decoded message 300 of layer L2, to be used for refining the quantized reading 130QR in at least one subsequent layer (e.g., L3, L4, . . . Lm), and so forth.

As shown in FIG. 2, one or more branches 200 of memory interface module 120 may include a noise correction module 180. In the implementation example of FIG. 2, all branches, save that pertaining to the most significant layer, may include a respective noise correction module 180.

According to some embodiments, memory interface module 120 may utilize noise correction module(s) 180 to implement a multi-stage decoding process to decode layers sequentially. This process may start from the first layer L₁ (MSB) and proceed through subsequent layers, recycling noise information from previously decoded layers to improve the decoding of later (less significant) layers.

Correction module 180 of a specific layer L may be adapted to apply post-decoding noise correction on the quantized reading 130QR of that layer, based on the determined digital noise level from previous layers (e.g., layers corresponding to more significant bits).

For example, as shown in FIGS. 2 and 3, correction module 180 of Layer L2 may obtain the determined digital noise level 170AS-t from one or more layers of higher bit significance (e.g., layer L₁) and correct or refine quantized reading 130QR in its layer (e.g., L2) based on the obtained digital noise level(s) 170AS-t (e.g., from layer L₁).

As explained herein, the noise level 170AS-t of layers of higher bit significance (e.g., MSB layer L₁) may have been calculated based on the quantized reading 130QR and the decoded read word 140RW (now message 300) of those layers (e.g., L1), hence the term “post-decoding” noise correction. This noise level 170AS-t (also denoted Zd1) may be subtracted from the quantized reading 130QR of a subsequent layer of lower bit significance (e.g., L₂) to produce a refined reading 130RR value of that layer (e.g., L2). As explained herein, in branch 200 of layer L2, mapping module 140 may produce a second read word 140RW, that may be decoded by decoder 150 to recover a second message 300 and compute a second digital noise level 170AS-t. The second digital noise level 170AS-t may be transferred to the subsequent branch, corresponding to layer L3, to refine the quantized reading of that branch, and so forth.

Additionally, or alternatively, a correction module of at least one branch 200 (e.g., Lm) may be configured to obtain a first digital noise level 170AS-t from the first branch (e.g., L1), obtain one or more second digital noise levels from one or more second branches (e.g., L2, . . . , L(m-1)) and refine the quantized reading of that branch (Lm) based on the obtained digital noise levels.

For example, as shown in FIG. 2, correction module 180 may apply post-decoding noise correction to the quantized reading 130QR in branch 200 of the least significant bit (LSB) layer, based on accumulated noise estimations from preceding layers. As illustrated in FIG. 2, the “Σ” (Sigma) block may indicate summation 170AS of the digital noise estimation values 170AS-t (also denoted Z_{d1}, . . . , Z_{d(m-1)}) from higher significance layers. This summed noise estimation 170AS may be subtracted from the quantized reading 130QR of the LSB layer (Lₘ), to produce a refined reading 130RR value of that layer. Refined reading 130RR is subsequently processed by the inverse mapping module 140 (M⁻¹) and decoding stage 150 of the LSB layer.

By utilizing this multi-stage decoding process with noise recycling, memory interface module 120 may be configured to decode the quantized reading 130QR and recover a multilayer message 10MLM encoded within the read multilayered symbol 30MLS. This recovered data, constituting multilayered message 10MLM, may then be provided to the computing device 20 in response to read access requests.

As shown in FIGS. 2 and 3, in one or more branch 200 (e.g., each branch, save that of the LSB layer Lm), noise recycling module 160 (also denoted ‘NR’) may process a message 300 and a corresponding read word 140RW through multiple processing stages. As shown in FIG. 4, message 300 may be input to an encoder module 190 (also denoted C_{enc,t}, indicating pertinence to layer t). Encoder module 190 may be configured to generate an expected codeword 310 based on the message 300.

The term “expected” may be used in this context to indicate a codeword (e.g., 140CW of FIG. 1B) that would have been written into device 10 according to a predetermined encoding scheme, given the implementation-specific encoding scheme and a specific binary input message 300. For example, the encoding scheme may be an appropriate encoding that includes error-correction properties. Given a specific binary input vector of a specific layer, encoder 190 may map this vector to a codeword in the designated code, thereby producing codeword 310.

In a simple, non-limiting example, the encoding scheme may be a 3-fold redundancy scheme, which may allow single-error detection and correction. Given a specific binary input value (e.g., ‘1’) of a specific layer (e.g., stored bit), encoder 190 may multiply that value 3 times, to comply with the 3-fold redundancy encoding scheme, thereby producing codeword 310 as “1, 1, 1”.

Read word 140RW and expected codeword 310 may be provided as inputs to a subtraction module 165 to produce analog noise estimation 165A. In other words, noise recycle module 160 may compare read word 140RW (which may represent actual read data) with the expected codeword 310 (which may represent ideal data, devoid of noise) to produce estimation 165A that indicates discrepancies attributed to noise.

Noise recycle module 160 may feed analog noise estimation 165A into a digital noise estimation module 170. Digital noise estimation module 170 may be configured to determine the noise characteristics of a specific layer t, based on expected codeword 310 in that layer (310-t, also denoted \grave{L}ᵤ_{ₗ}) and the actual read word 140RW in that layer (140RW-t).

As explained herein, layer-specific digital noise estimation 170AS-t (also denoted \grave{Z}_{d}_{ₜ}) produced by the digital noise estimation module 170 may be used by the correction module 180 of subsequent layers. Correction module 180 may subtract the estimated digital noise from the quantized reading 130QR before decoding subsequent layers, thereby improving accuracy of decoding for lower significance bits of the multilayered symbol.

In some embodiments, the output of digital noise estimation module 170 (e.g., 170AS-t) may further indicate the indices of noisy cells and the direction of the required correction for subsequent layers. The noise estimation magnitude may be determined based on the difference between current and previous MLS estimations. The direction of correction may be inherently provided by the calculated difference between the estimated bit-value and the read bit-value. The algorithm may operate iteratively and greedily, applying post-decoding noise corrections in the opposite direction of the identified noise. This approach may mitigate the noise within the cell, thereby enhancing the BER for subsequent layers.

When the mapping scheme is BP mapping, the direction (sign) of the noise may be inherently determined from the bit flip observed in the read word 140RW. For example, when a bit flips from ‘0’ to ‘1’ at a given layer, the noise may be determined to be positive (e.g., the cell's voltage was shifted upward). Conversely, when a bit flips from ‘1’ to ‘0’, the noise may be determined to be negative (i.e., the cell's voltage was shifted downward). This directional information may be used by the noise recycling module 160 to determine the sign of the digital noise estimation 170AS-t, and consequently the direction of the correction applied by correction module 180 in subsequent layers.

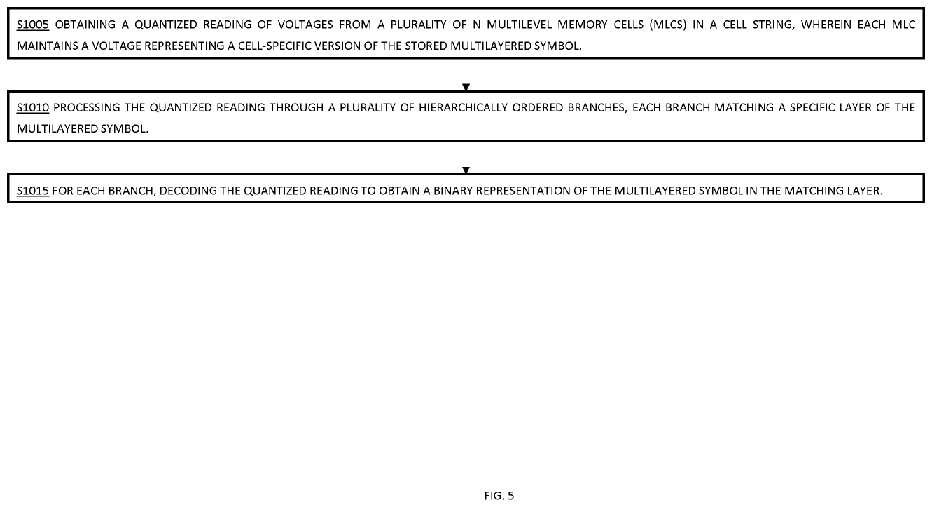

Reference is now made to FIG. 5, which is a flow diagram depicting a method of decoding a stored multilayered symbol in a multilayered memory storage device.

As shown in step S1005, embodiments of the method may include obtaining a quantized reading of voltages from a plurality of N multilevel memory cells (MLCs) in a cell array, where each MLC maintains a voltage level representing a respective multilayered symbol.

As shown in step S1010, embodiments of the method may include processing the quantized reading through a plurality of hierarchically ordered branches, each branch matching a specific layer of the multilayered symbol.

As shown in step S1015, embodiments of the method may include, for each branch, decoding the quantized reading to obtain a message of the multilayered symbol in the matching layer.

As explained herein, processing through at least one first branch may include decoding the quantized reading to obtain the message of the multilayered symbol in the matching layer; and determining a digital noise level at the matching layer in at least one MLC based on the message.

Additionally, processing through at least one second, subsequent branch may include applying post-decoding noise correction on the quantized reading based on the determined digital noise level of the at least one first branch, thereby refining the quantized reading; and decoding the refined quantized reading to obtain the message of the multilayered symbol at its matching layer.

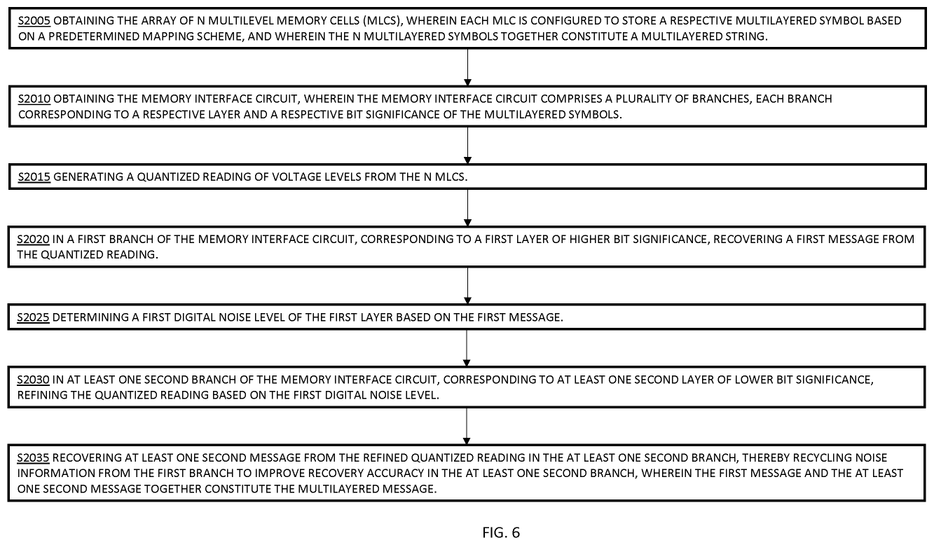

Reference is now made to FIG. 6, which is a flow diagram depicting a method of recovering a multilayered message from an array of N multilevel memory cells, according to some embodiments of the present invention.

As shown in step S2005, embodiments of the method may include obtaining an array of N multilevel memory cells (MLCs), wherein each MLC is configured to store a respective multilayered symbol based on a predetermined mapping scheme, and wherein the N multilayered symbols together constitute a multilayered string. For example, cell array 110 of multilayered memory device 10 may include N memory cells 111, each adapted to maintain a voltage level representing a respective multilayered symbol (MLS). Mapping scheme may be, for example, a Block Partition (BP) mapping scheme or a Gray mapping scheme, as described herein with reference to FIG. 3.

As shown in step S2010, embodiments of the method may further include obtaining a memory interface circuit (also referred to as memory interface module) that includes a plurality of branches, each branch corresponding to a respective layer and a respective bit significance of the multilayered symbols. For example, memory interface module 120 may include a plurality of hierarchically ordered branches 200, as described herein with reference to FIG. 2. Each branch 200 may correspond to a respective layer (e.g., L₁ through Lₘ) and a respective bit significance (e.g., from MSB to LSB) of the multilayered symbols stored in cell array 110.

As shown in step S2015, embodiments of the method may include generating a quantized reading of voltage levels from the N MLCs. For example, device 10 may receive a data read request from a host computer 20 (also referred to as host device 20, computing device 20, and the like). Device 10 may consequently perform a read action, to obtain each cell's voltage levels as known in the art. Quantization module 130 of memory interface module 120 may compare the obtained voltage levels against a set of read voltage thresholds, to determine which of the 2^{m} possible representation levels each cell's voltage falls within, thereby producing a quantized reading 130QR of MLCs 111.

As shown in step S2020, embodiments of the method may include, in a first branch of the memory interface circuit corresponding to a first layer of higher bit significance, recovering a first message from the quantized reading. For example, in a first branch 200 corresponding to layer L₁ (e.g., the MSB layer), inverse mapping module 140 may extract a read word 140RW from quantized reading 130QR, and decoding module 150 may decode read word 140RW to recover a message 300 pertaining to the first layer.

As shown in step S2025, embodiments of the method may include determining a first digital noise level of the first layer based on the first message. For example, noise recycling module 160 of the first branch 200 may process message 300 and read word 140RW to determine digital noise estimation 170AS-t for the first layer, as described herein with reference to FIG. 4.

As shown in step S2030, embodiments of the method may include, in at least one second branch of the memory interface circuit corresponding to at least one second layer of lower bit significance, refining the quantized reading based on the first digital noise level. For example, correction module 180 of a second branch 200 may subtract digital noise estimation 170AS-t from quantized reading 130QR, to produce refined reading 130RR for the second layer L2 corresponding to the second branch 200.

As shown in step S2035, embodiments of the method may include recovering at least one second message from the refined quantized reading in the at least one second branch, thereby recycling noise information from the first branch to improve recovery accuracy in the at least one second branch. For example, in a second branch 200, inverse mapping module 140 may extract a read word 140RW from refined reading 130RR, and decoding module 150 (also referred to as “decoder” 150) may process read word 140RW to recover message 300 pertaining to the second layer.

The first recovered message 300 and the at least one second recovered message 300 may together constitute a multilayered message that is encoded within a multilayered string, stored in cell array 110. In other words, messages 300 recovered from all branches 200 (e.g., U₁ through Uₘ) may together form a reconstructed multilayered message 10MLM that may be returned to computing device 20 in response to a data access request (e.g., a read access request).

According to some embodiments, recovering multilayered message 10MLM may include an iterative recovery process. With reference to FIG. 2, the iterative recovery process may follow decreasing bit significance across the plurality of branches 200, from a branch 200 of an MSB layer to a branch 200 of an LSB layer. Each iteration may pertain to a respective branch 200.

In other words, the memory interface 120 may process the quantized reading 130QR through the branches 200 in a sequential manner, starting with the branch 200 corresponding to the MSB layer (e.g., layer L₁) and proceeding through intermediate layers (e.g., layers L₂, L₃, and so forth) until reaching the branch 200 corresponding to the LSB layer (e.g., layer Lₘ). At each iteration, the memory interface 120 may perform decoding operations specific to the respective branch 200, and may determine digital noise characteristics that can be recycled for use in subsequent iterations (e.g., subsequent, lower significance layers).

For example, in a first iteration pertaining to the branch 200 of the MSB layer, the inverse mapping module 140 may extract a read word 140RW from the quantized reading 130QR, and the decoding module 150 may decode the read word to recover a message 300 for that layer. The noise recycle module 160 may then determine the digital noise estimation 170AS for the MSB layer based on the recovered message. In a second iteration pertaining to a subsequent branch 200 of lower bit significance, the correction module 180 may refine the quantized reading 130QR based on the digital noise estimation 170AS from the previous iteration, producing the refined reading 130RR. The inverse mapping module 140 and the decoding module 150 of that branch 200 may then process the refined reading 130RR to recover a message for that layer. This iterative process may continue through all branches 200 until the branch 200 of the LSB layer is reached, at which point the reconstructed multilayered message 10MLM may be assembled from messages 300 recovered across all iterations.

With continued reference to FIG. 2, a first iteration of the iterative recovery process, pertaining to the branch 200 of the MSB layer (e.g., layer L₁), may include several processing stages. In the first iteration, the inverse mapping module 140 may apply inverse mapping on the quantized reading 130QR to extract a read word pertaining to the MSB layer. As shown in FIG. 1B, the read word may also be referred to as a codeword 140CW. The codeword 140CW may include a plurality of binary values, where each binary value represents crossing of a voltage threshold in a respective memory cell 111 at the MSB layer.

Following extraction of the codeword 140CW, the decoding module 150 of the branch 200 corresponding to the MSB layer may decode the read word to recover a message pertaining to the MSB layer. The recovered message may be referred to as a decoded binary value 300, as shown in FIG. 2. The decoding module 150 may apply error correction logic, as described previously, to produce the decoded binary value 300 from the codeword 140CW.

After recovering the decoded binary value 300 for the MSB layer, the noise recycle module 160 of the branch 200 corresponding to the MSB layer may calculate the digital noise level of the MSB layer based on the recovered MSB layer message. As described previously with reference to FIG. 2, the digital noise estimation 170AS may be determined by comparing the decoded binary value 300 with the codeword 140CW extracted from the quantized reading 130QR. The digital noise estimation 170AS calculated for the MSB layer may then be transferred to subsequent branches 200 of lower bit significance, where the correction module 180 may use the digital noise estimation 170AS to refine the quantized reading 130QR before decoding subsequent layers.

With continued reference to FIG. 4, each iteration of the iterative recovery process save that pertaining to the branch 200 of the MSB layer may include several processing stages that utilize noise information from previously decoded layers. In these subsequent iterations, the correction module 180 of the current branch 200 may refine the quantized reading 130QR at a current branch 200 corresponding to a current layer, based on a digital noise level of one or more layers of higher bit significance. As described herein, the correction module 180 may accumulate digital noise estimations 170AS of previous, higher significance layers (e.g., from an iteration pertaining to the branch of the MSB layer through an iteration immediately preceding the current iteration), and subtract the accumulate digital noise estimations 170AS the from the quantized reading 130QR, to produce the refined reading 130RR for the current layer.

Following refinement of the quantized reading 130QR, the inverse mapping module 140 of the current branch 200 may apply inverse mapping on the refined quantized reading 130RR to extract a read word 140RW pertaining to the current layer. Read word 140RW may include a plurality of binary values, where each binary value represents crossing of a voltage threshold in a respective memory cell 111 at the current layer.

After extraction of the read word 140RW from refined reading 130RR, the decoding module 150 of the current branch 200 may decode the read word to recover a message 300 pertaining to the current layer. Decoding module 150 may apply error correction logic on the codeword 140CW as part of the decoding, to produce message 300, as described herein.

Following recovery of the decoded binary value 300 for the current layer, the digital noise estimation module 170 may calculate the digital noise level 170AS of the current layer (170AS-t) based on the recovered message 300 of the current layer. In some embodiments, calculating the digital noise level of the current layer may include generating an expected codeword 310 based on the recovered message 300 of the current layer, comparing the expected codeword 310 with the read word 140RW of the current layer, and determining the digital noise level of the current layer based on the comparison. For example, as shown in FIG. 4, encoder module 190 may generate expected codeword 310 based on the decoded binary value 300, and noise recycle module 160 may compare expected codeword 310 with read word 140RW. Discrepancies between expected codeword 310 and read word 140RW may indicate noise-induced errors, and the digital noise estimation 170AS-t for the current layer may be determined based on the comparison.

Alternatively, or additionally, calculating the digital noise level of the current layer may include employing a decoder to calculate estimated bit-values corresponding to respective indices of the read word 140RW, comparing the estimated bit-values with the read word 140RW of the current layer, and determining the digital noise level based on the comparison. For example, decoding module 150 may be used to calculate estimated bit-values for each index of read word 140RW based on the recovered message 300. These estimated bit-values may then be compared with the actual bit-values of read word 140RW, and the digital noise level 170AS-t may be determined based on the comparison.

In each iteration save that pertaining to the branch of the LSB layer, the digital noise estimation 170AS-t may be transferred to subsequent branches 200 of lower bit significance, where the correction module 180 may use the accumulated digital noise estimations to refine the quantized reading 130QR of the subsequent branches 200 before decoding the read word 140RW.

As explained herein, digital noise estimation module 170 may calculate digital noise estimation 170AS of each layer, and each MLC 111, depending on the implemented encoding scheme.

In some embodiments, determining the digital noise level of the current layer may include, based on the comparison between the expected codeword 310 and the read word 140RW, detecting a bit flip in an index of the read word 140RW, said index corresponding to an identified MLC 111. For example, if the expected codeword 310 at a given index has a value of ‘0’ and the read word 140RW at the same index has a value of ‘1’, or vice versa, a bit flip may be detected at that index, and the MLC 111 corresponding to that index may be identified as a noisy cell.

When the predetermined mapping scheme is a Block Partition (BP) mapping scheme, determining the digital noise level of the current layer may further include, based on bit significance of the current layer, determining an amplitude of the digital noise level in the identified MLC 111, and relying on the BP mapping to determine a sign of the digital noise in the identified MLC 111. As described herein with reference to paragraph [0079], in BP mapping, the direction (sign) of the noise may be inherently determined from the bit flip observed in the read word 140RW. For example, when a bit flips from ‘0’ to ‘1’, the noise may be determined to be positive, and when a bit flips from ‘1’ to ‘0’, the noise may be determined to be negative. The amplitude of the digital noise level may be determined based on the bit significance of the current layer, as the bit significance may indicate the magnitude of the voltage shift corresponding to the detected bit flip.

Additionally, or alternatively, when the predetermined mapping scheme is a BP mapping scheme, the method may further include, based on the comparison, detecting a bit flip in an index of the read word 140RW of the current layer, said index corresponding to an identified MLC 111, and predicting occurrence of errors in at least one subsequent layer of the identified MLC 111, from the layer directly subsequent the current layer through the LSB layer. As described herein, in BP mapping, if two neighboring multilayered symbol values differ in the t-th bit, they may also differ in all subsequent bits. Therefore, when a bit flip is detected at a given layer in an identified MLC 111, errors may be predicted to occur in all subsequent layers of that MLC 111, from the layer directly subsequent the current layer through the LSB layer.

When the predetermined mapping scheme is a Gray mapping scheme, determining the digital noise level of the current layer may include, based on the comparison, detecting a bit flip in an index of the read word 140RW, said index corresponding to an identified MLC 111, and based on bit significance of the current layer, determining an amplitude of the digital noise level in the identified MLC 111. In contrast to BP mapping, in Gray mapping, a bit flip alone may not suffice to determine the sign (direction) of the noise. Therefore, in some embodiments using Gray mapping, the amplitude of the digital noise level may be determined without necessarily determining the sign of the digital noise from the bit flip alone.

Embodiments of the invention may provide several technical advantages over existing approaches to multi-level cell flash memory decoding. By recycling noise information estimated from higher-significance layers to refine the quantized reading of lower-significance layers, embodiments of the invention may achieve improved bit error rates (BER) and higher storage rates compared to independent decoding schemes that do not exploit inter-layer noise correlation.

As explained herein, the noise recycling approach of the present invention may be implemented within the memory interface circuit of a multilayered memory storage device, using specific hardware components such as inverse mapping modules, decoding modules, noise recycling modules, and correction modules arranged in hierarchically ordered branches. This arrangement may enable the memory interface circuit to perform layer-by-layer recovery of stored data with progressively refined quantized readings, producing a measurable reduction in decoding errors.

In some embodiments, the noise recycling approach may operate in the discrete domain using hard-decision recovery, without requiring soft information or likelihood calculations. This may reduce computational complexity and eliminate the need for multiple read operations at different voltage thresholds, which may be advantageous for practical implementation in flash memory controllers and storage systems.

The noise recycling approach of the present invention may be rooted in the physical characteristics of MLC flash memory. For example, because all layers of a given MLC may be read simultaneously, the noise affecting each layer within that MLC may share a common underlying noise component. Embodiments of the invention may exploit this correlated noise realization to estimate and correct noise across layers, which may be a technique that is specific to the physical structure and operation of multilevel memory cells.

Additionally, embodiments of the invention may leverage properties of specific mapping schemes, such as Block Partition (BP) mapping, to determine both the amplitude and direction of noise from detected bit flips. This directional noise information may enable more accurate noise correction in subsequent layers, further improving the reliability of the recovered multilayered message.

Additionally, or alternatively, the noise recycling approach of the present invention may enable flash memory systems to support higher storage densities while maintaining acceptable error rates, which may be beneficial for applications ranging from consumer electronics to data centers.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A multilayered memory storage device comprising:
a cell array comprising N multilevel memory cells (MLCs), each MLC adapted to maintain a voltage level representing a respective multilayered symbol, wherein the N multilayered symbols together form a multilayered string; and
a memory interface circuit comprising a plurality of branches, each branch corresponding to a respective layer of the multilayered symbols, wherein the memory interface circuit is configured to:
obtain a quantized reading of the voltage levels maintained in the N MLCs;
in a first branch corresponding to a first layer of higher bit significance, recover a first message from the quantized reading;
determine a first digital noise level of the first layer based on the first message;
in one or more second branches, respectively corresponding to one or more second layers of lower bit significance, refine the quantized reading based on the first digital noise level; and
recover one or more second messages from the refined quantized reading, thereby recycling noise information from the first branch to improve recovery accuracy in the one or more second branches.

2. The device of claim 1, wherein the memory interface circuit is configured to:
receive a data access request from a host computing device;
in response to the data access request, perform the quantized reading of the N MLCs to obtain the first message and the one or more second messages, wherein the first message and the one or more second messages together constitute a multilayered message; and
return the multilayered message to the host computing device as read data.

3. The device of claim 1, wherein data is stored on the MLCs based on a predetermined mapping scheme, and wherein the first branch comprises:
a mapping module adapted to perform inverse mapping on the quantized reading, to generate a first read word comprising a plurality of binary values, each binary value representing crossing of a voltage threshold in a respective MLC at the first layer;
a decoder module, adapted to decode the first read word, thereby recovering the first message; and
a noise recycling module, adapted to determine the first digital noise level of the first layer based on the first message.

4. The device of claim 1, wherein data is stored on the MLCs based on a predetermined mapping scheme, and wherein each of the one or more second branches comprises:
a correction module, adapted to (i) obtain the first digital noise level from the first branch and (ii) refine the quantized reading of that second branch based on the obtained first digital noise level;
a mapping module adapted to perform inverse mapping on the refined quantized reading, to generate a second read word comprising a plurality of binary values, each binary value representing crossing of a voltage threshold in a respective MLC at the layer corresponding to that second branch; and
a decoder module, adapted to decode the second read word, thereby recovering the second message pertaining to that second branch.

5. The device of claim 1, wherein at least one of the one or more second branches comprises a noise recycling module, adapted to determine a second digital noise level based on the second message pertaining to that second branch.

6. The device of claim 5, wherein a subsequent branch of the one or more second branches comprises a correction module adapted to (i) obtain the first digital noise level from the first branch, (ii) obtain second digital noise levels from the at least one second branch and (iii) refine the quantized reading of the subsequent branch based on the obtained digital noise levels.

7. The device of claim 1, wherein the memory interface circuit is configured to obtain the quantized reading by simultaneously reading all layers of the MLCs in the cell array, thereby ensuring a correlated noise realization across all layers within each MLC.

8. The device of claim 1, wherein the memory interface circuit is configured to operate in a discrete domain using hard-decision recovery, wherein refining the quantized reading in the one or more second branches is based on discrete noise values calculated for one or more branches of higher bit significance, without requiring soft information or likelihood calculations.

9. A method of recovering a multilayered message from an array of N multilevel memory cells by a memory interface circuit, the method comprising:
obtaining the array of N multilevel memory cells (MLCs), wherein each MLC is configured to store a respective multilayered symbol based on a predetermined mapping scheme, and wherein the N multilayered symbols together constitute a multilayered string;
obtaining the memory interface circuit, wherein the memory interface circuit comprises a plurality of branches, each branch corresponding to a respective layer and a respective bit significance of the multilayered symbols;
generating a quantized reading of voltage levels from the N MLCs;
in a first branch of the memory interface circuit, corresponding to a first layer of higher bit significance, recovering a first message from the quantized reading;
determining a first digital noise level of the first layer based on the first message;
in at least one second branch of the memory interface circuit, corresponding to at least one second layer of lower bit significance, refining the quantized reading based on the first digital noise level; and
recovering at least one second message from the refined quantized reading in the at least one second branch, thereby recycling noise information from the first branch to improve recovery accuracy in the at least one second branch,
wherein the first message and the at least one second message together constitute the multilayered message.

10. The method of claim 9, wherein recovering the multilayered message comprises an iterative recovery process following decreasing bit significance across the plurality of branches, from a branch of a Most Significant Bit (MSB) layer to a branch of a Least Significant Bit (LSB) layer, and wherein each iteration pertains to a respective branch.

11. The method of claim 10, wherein a first iteration, pertaining to the branch of the MSB layer comprises:
applying inverse mapping on the quantized reading, to extract a read word pertaining to the MSB layer, wherein the read word comprises a plurality of binary values, each binary value representing crossing of a voltage threshold in a respective MLC at the MSB layer;
decoding the read word to recover a message pertaining to the MSB layer; and
calculating the digital noise level of the MSB layer based on the recovered MSB layer message.

12. The method of claim 10, wherein each iteration save that pertaining to the branch of the MSB layer comprises:
refining the quantized reading at a current branch corresponding to a current layer, based on a digital noise level of one or more layers of higher bit significance;
applying inverse mapping on the refined quantized reading, to extract a read word pertaining to the current layer, wherein the read word comprises a plurality of binary values, each binary value representing crossing of a voltage threshold in a respective MLC at the current layer;
decoding the read word to recover a message pertaining to the current layer; and
calculating the digital noise level of the current layer based on the recovered message of the current layer.

13. The method of claim 12, wherein each iteration save that pertaining to the branch of the LSB layer further comprises transferring the calculated digital noise level to a subsequent iteration, pertaining to a subsequent branch of a lower bit significance, for refining the quantized reading in the subsequent branch.

14. The method of claim 12, wherein decoding the read word further comprises applying error correction logic on the read word to correct the recovered message in the current layer.

15. The method of claim 12, wherein calculating the digital noise level of the current layer comprises:
generating an expected codeword based on the recovered message of the current layer;
comparing the expected codeword with the read word of the current layer; and
determining the digital noise level of the current layer based on the comparison.

16. The method of claim 12, wherein calculating the digital noise level of the current layer comprises:
employing a decoder to calculate estimated bit-values corresponding to respective indices of the read word;
comparing the estimated bit-values with the read word of the current layer; and
determining the digital noise level based on the comparison.

17. The method of claim 12, wherein refining the quantized reading of the current layer comprises:
accumulating digital noise levels determined in previous iterations, from an iteration pertaining to the branch of the MSB layer through an iteration immediately preceding a current iteration; and
subtracting the accumulated digital noise levels from the quantized reading to produce the refined quantized reading of the current layer.

18. The method of claim 12, wherein the predetermined mapping scheme is a Block Partition (BP) mapping scheme, and wherein determining the digital noise level of the current layer comprises:
based on the comparison, detecting a bit flip in an index of the read word, said index corresponding to an identified MLC;
based on bit significance of the current layer, determining an amplitude of the digital noise level in the identified MLC; and
relying on the BP mapping to determine a sign of the digital noise in the identified MLC.

19. The method of claim 12, wherein the predetermined mapping scheme is a Block Partition (BP) mapping scheme, and wherein the method further comprises:
based on the comparison, detecting a bit flip in an index of the read word of the current layer, said index corresponding to an identified MLC;
predicting occurrence of errors in at least one subsequent layer of the identified MLC, from the layer directly subsequent the current layer through the LSB layer.

20. The method of claim 12, wherein the predetermined mapping scheme is a Gray mapping scheme, and wherein determining the digital noise level of the current layer comprises:
based on the comparison, detecting a bit flip in an index of the read word, said index corresponding to an identified MLC;
based on bit significance of the current layer, determining an amplitude of the digital noise level in the identified MLC.
